(19) United States
(12) Patent Application Publication
(10) Pub. No.: US 2020/0156672 A1
(43) Pub. Date: May 21, 2020

(54) Method for Loading/Unloading a Road Semi-Trailer for a Pocket Wagon and a Pocket Wagon Suitable for This Method

(71) Applicant: LOHR INDUSTRIE, Hangenbieten (FR)

(72) Inventors: Jean-Luc Andre, Molsheim (FR); Sébastien Lange, Strasbourg (FR); Jacques Ober, Strasbourg (FR); Mathieu Schverer, Hurtigheim (FR)

(21) Appl. No.: 16/615,600

(22) PCT Filed: Jun. 29, 2018
(86) PCT No.: PCT/FR2018/051616

§ 371 Date: Nov. 21, 2019

(30) Foreign Application Priority Data
Jun. 30, 2017 (FR) 1756216

(51) Int. Cl. B61D 47/00; B65G 67/04; B61D 3/18

(52) U.S. Cl. CPC B61D 47/005; B65G 2814/03; B61D 3/184; B65G 67/04

(57) ABSTRACT

A method includes grasping, with a handling machine, the removable shell of the pocket wagon, lifting it and setting it down outside the receptacle of the railway structure, preferably on the platform or at an angle across the railroad tracks. The method also includes equipping a locking device on the kingpin of the semi-trailer previously disconnected from its road tractor and loading the semi-trailer by means of a handling machine, by causing it to roll on the bottom wall of the removable shell. The method further includes attaching the locking device to the removable shell, and grasping the loaded shell with the handling machine, lifting it and loading it on the pocket wagon by engaging it in the receptacle of the railway structure.

### TECHNICAL FIELD

The present invention belongs to technical field of rail transport of road semi-trailers, trucks and/or receptacles. More specifically, it concerns a method for loading and unloading a road semi-trailer on a pocket wagon rail wagon to enable it to be transported on the rail wagon.

The invention also concerns a removable assembly and a pocket wagon which are adapted to implement this loading method and which are intended to mainly accommodate a semi-trailer, but also potentially a truck or a receptacle.

### BACKGROUND OF THE DISCLOSURE

To limit congestion on roads and highways and the pollution generated by road transport, we want to develop semi-trailer rail transport.

The semi-trailers are thus loaded, according to different techniques, onto specialist wagons in intermodal road and rail terminals, which are specially equipped to carry out these operations. They are then transported by train over long distances, rather than on the road network.

Numerous examples of specific wagons have been described in the prior art. The most frequently used are wagons which are consisting of a running base and an upper railway structure which can be pivoted to be separated from its base. Depending on the models, this pivoting may be done centrally or at one of its ends. The wagon is thus able to open up to facilitate the loading/unloading of the semi-trailers. In fact, by pivoting, the upper railway structure is able to place itself at an angle to rest on or above the platform by one or both of its ends. The semi-trailers can then be loaded and unloaded easily, using an adapted ramp, on this bearer railway structure which, once loading/unloading has been carried out, goes back to the transport position according to the wagon's longitudinal direction by pivoting in the opposite direction.

An example of this type of loading method by means of pivoting bearer platform wagons has been described in European patent EP 1,292,478.

Although they provide high levels of performance in terms of loading height, these systems are very complex and very expensive. In fact, they require the production of wagons which are able to open and pivot their upper portion when they are stopped to load/unload, then close and reassemble again with enough solidity to guarantee control over all efforts during transport and transport the semi-trailers in complete safety.

In addition, with this type of wagons from the prior art, the semi-trailers are only locked for transport once they are placed in the transport position on the wagon, after the bearer structure has pivoted fully. This locking is performed most often via the semi-trailer's coupling pin and using a locking mechanism supported by the wagon. This means that during loading or unloading operations the semi-trailer is not held when the bearer structure is pivoting and is simply supported by its stands. The step wherein the bearer structure pivots is therefore tricky to implement and relatively risky. This also means that the semi-trailer must be positioned carefully in the bearer structure so that its coupling pin is aligned with or close to the locking mechanism carried by the wagon.

To remedy these disadvantages, another type of semi-trailer transport wagon was proposed in the prior art. These are removable shell or nacelle wagons, such as those described in patents EP 0,619,211 et FR 2,884,480.

These earlier wagons comprise a rail running base with a hollow central portion, which forms a receptacle adapted to accommodate and hold a removable nacelle provided to support the semi-trailer to be transported. To carry out the loading/unloading operations, this nacelle is taken and raised by a vertical handling machine such as a crane or gantry and is extracted from the wagon to be deposited on the platform. The semi-trailer is then loaded onto the nacelle and the assembly is put back onto the railway structure by the vertical handling machine.

Nacelle systems of this type are solutions which are much simpler in technical terms and are much less expensive than the turntable wagons described above. In addition, as they do not require any complex mechanisms on the wagon, they are lighter.

However, the devices mentioned above still have disadvantages.

With the device described in patent EP 0,619,211, no mechanism to hold the semi-trailer's coupling pin is provided on the removable nacelle. When the handling machine moves the loaded nacelle to place it on the railway structure, the semi-trailer is not locked, but is simply resting on its stands with all the stability and safety problems that implies.

In addition and as previously, the semi-trailer is locked by its coupling pin on the wagon, and therefore the operator must position it carefully and carry out manual operations on the wagon.

In patent FR 2 884 480, an attempt was made to remedy these problems by adding a device to attach the semi-trailer coupling pin. This attachment device comprises an attachment base whereof extends an adjustable-height central column, terminating in its upper portion with a coupling seat for the semi-trailer coupling pin. To be operated, this attachment device must be mounted on the nacelle by engaging its base in the supplementary reception means located at the front and middle of the nacelle's bottom wall.

A second, more practical embodiment has also been described in this previous document. In this embodiment, the attachment base is replaced by a crossbeam which is attached to a hinge located on the edges of the nacelle. This crossbeam includes a coupling seat and several rows of perforations at its ends, wherein the operator must insert a set of pins to secure the crossbeam to the hinges of the nacelle.

In both cases, to load a semi-trailer using these devices, the operator starts by placing the nacelle on the platform and driving the semi-trailer onto it. Once correctly in position, the semi-trailer is placed on its stands and left by its tractor. The operator must then position the removable coupling pin attachment mechanism, in order to lock the semi-trailer onto the nacelle.

To do this, the operator must simultaneously push the coupling seat onto the semi-trailer's coupling pin, and secure the attachment device onto the nacelle. This operation is quite laborious for the operator as it is tricky to carry out. In fact, it assumes that the column height of the attachment device in the first embodiment is perfectly adjusted or that the pins in the second embodiment have been placed in the right perforations, and also that the semi-trailer has been placed precisely onto the nacelle so that its coupling pin is in the right position. This means that if the tractor leaves the semi-trailer slightly too far forward or back, or if the column height or pin settings are incorrect, it is impossible to simultaneously lock the coupling base to the coupling pin and the attachment device to the nacelle. The operator must then restart the settings and/or couple the tractor to the semi-trailer again and move it to its precise loading position again. Once the tractor has left, a new attempt must then be made to put the attachment device in place.

All of these difficulties explain why this operation to position the removable attachment device, which is tricky and laborious, and which is also carried out under the semi-trailer with no visibility for the operator, has considerably slowed down the development of this previous semi-trailer loading system.

The semi-trailer loading/unloading method and system according to the invention are intended to remedy these various disadvantages with the prior art.

### SUMMARY OF THE DISCLOSURE

To do this, the invention presents a new method for loading a road semi-trailer on a pocket wagon comprising a receptacle railway structure and a removable road semi-trailer loading/unloading assembly, including:

a removable shell, intended to be removably engaged in the railway structure receptacle, which comprises a bottom wall, two side walls and two longitudinal beams located in the upper portion above the sides walls, the assembly forming a loading pocket for the semi-trailer; and which also comprises the first immobilization elements and mechanical interfaces able to cooperate with the gripping elements of a handling machine; and

a locking device, which comprises the second immobilization elements cooperating with the first immobilization elements to ensure the removable attachment of the locking device on the removable shell; and a coupling seat for the semi-trailer coupling pin to anchor the semi-trailer to the removable shell.

According to the invention, the method comprises the following steps:

taking hold of the removable shell by pushing the gripping elements of a handling machine into the removable shell's mechanical interfaces, and, using the handling machine, raise the removable shell and place it away from the railway structure receptacle;

fitting the locking device on the semi-trailer which was previously left by its road tractor, by engaging the semi-trailer coupling pin into the coupling seat in the locking device;

loading the semi-trailer equipped with the locking device onto the removable shell using a handling tractor, running it forward or in reverse onto the bottom wall of the removable shell, between the side walls and the longitudinal beams;

using the handling tractor, placing the locking device on the removable shell, in a position which enables the second immobilization elements to cooperate with the first immobilization elements;

releasing the handling tractor and moving it away from the removable assembly;

taking hold of the loaded removable assembly by engaging the handling machine's gripping elements into the mechanical elements of the removable shell and raising the loaded removable assembly;

using the handling machine, place the loaded removable assembly onto the railway structure, engaging the removable shell in the railway structure receptacle.

Depending on the circumstances, the removable shell may be in a storage area or be engaged in the railway structure receptacle, before being taken hold of and raised using the handling machine.

When the railway structure is on a railway line near a platform, the handling machine may, depending on the embodiments, place the removable shell beside the railway structure on the platform, or on top of the railway structure sideways in relation to the railway line, during the step wherein the removable shell is placed away from the railway structure receptacle.

The second of these variants, which is made for a track in a pit, advantageously enables the flow of handling machines and semi-trailers on the terminal to be optimized. The shell is then removed preferably diagonally above the wagon, approximately to the center of it and resting on the infrastructure's side platforms.

According to one preferred embodiment of this invention, the removable shell is maintained in the longitudinal position using the support elements present on the under side of the bottom wall, which are against the edges of the platform or the railway structure.

According to one embodiment of the method according to the invention, when the removable shell is raised and placed away from the railway structure receptacle with the handling machine, a first semi-trailer can be on the removable shell. This first semi-trailer is then unloaded away from the removable shell before a second semi-trailer is loaded on the removable shell, during the step which consists of loading the semi-trailer equipped with the locking device on the removable shell by means of a handling tractor, running it forward or in reverse onto the bottom wall of the removable shell, between the side walls and the longitudinal beams.

In this case, this first semi-trailer which was initially present on the removable shell is unloaded by means of the handling tractor which reverses to lock the locking device on the lifting reactor, then which runs the first semi-trailer forward or in reverse on the bottom wall of the removable shell, between the side walls and the longitudinal beams.

According to a preferred embodiment of the method according to the invention, when the semi-trailer equipped with the locking device is loaded onto the removable shell by means of a handling tractor, the handling tractor brings the locking device close to the longitudinal beams and moves gradually until the locking device touches the positioning stops of a positioning device which is on the removable shell, which indicates that the locking device is correctly positioned lengthwise so that the second immobilization elements can cooperate with the first immobilization elements, so that these first immobilization elements are engaged with said second immobilization elements.

According to this embodiment, after the locking device is positioned longitudinally, the operator may adjust its height by deflating the handling tractor's suspension.

According to one embodiment, the locking device may be locked longitudinally on one side by these positioning stops and on the other by positioning device jamming stops.

The invention also concerns a removable loading/unloading assembly for a road semi-trailer on a receptacle railway structure of a pocket wagon, which enables the invention's loading method to be implemented.

This removable assembly includes:

a removable shell, intended to be removably engaged in the railway structure receptacle, which comprises a bottom wall onto which the semi-trailer is loaded, and mechanical interfaces able to cooperate with the gripping elements of a handling machine to raise and drop the removable shell; and

a locking device, which comprises a coupling seat for the semi-trailer coupling pin and which is removably attached to the removable shell, on a side of it defined as being the front side, in order to anchor the semi-trailer to the removable shell.

The removable shell also comprises:

two longitudinal beams, located in the upper portion of the removable shell, and each comprising a front end portion which extends at an angle towards the front beyond the bottom wall,

first immobilization elements located on the front end portion of the longitudinal beams, and

two side walls, which border the side of the bottom wall and extend upwards to the longitudinal beams, with these side walls and the bottom wall forming a loading pocket for the semi-trailer.

In addition, the locking device comprises:

a base whereon the coupling seat is assembled, this base being a crossbeam which is removably attached by its ends onto the front end portion of the longitudinal beams, and

second immobilization elements which cooperate with the first immobilization elements to hold the locking device onto the removable shell.

Thus, when the locking device is secured to the removable shell, the space under the front end portion of the longitudinal beams remains free.

According to the invention, the removable shell also comprises a positioning device, which comprises two positioning stops, located one on each front end portion of the longitudinal beams, which, when the locking mechanism touches these positioning stops without said first immobilization elements being engaged with said second immobilization elements, guaranteeing an adapted longitudinal position for the locking device in relation to the removable shell so that the first immobilization elements and the second immobilization elements can cooperate.

According to one embodiment, the positioning device also comprises two jamming stops, located one on each front end portion of the longitudinal beams, which enable the locking device to be locked longitudinally between the positioning stops and the jamming stops of the positioning device.

According to a preferred embodiment, the positioning stops and/or the jamming stops are mobile or removable or retractable or tilting stops.

Thanks to the positioning device according to the invention, the operator who drives the handling tractor may very easily control, on their own, the positioning of the locking device on the removable shell and ensure optimum positioning of it, corresponding precisely to the engagement of the complementary immobilization elements, without needing to get out of the handling tractor to inspect this position visually, or to maneuver several times to obtain this precise position.

The long and laborious positioning operations imposed by the methods and devices of the prior art are thus advantageously avoided.

According to one embodiment, the mechanical interfaces are located on the longitudinal beams and are openings or cavities which are adapted to gripping by the clamps of a handling machine with clamps or are ISO wedges.

According to one embodiment, the removable shell also comprises a set of support elements on the underside of the bottom wall.

According to one embodiment, these support elements may be pivoting, folding or retractable.

According to one embodiment, these support elements are laid out in two diagonal rows.

According to one embodiment, the removable shell also comprises a centering device which makes it easier to engage the removable shell in the railway structure receptacle.

Preferably, this centering device may be a set of two longitudinal chamfers which connect the side walls to the bottom wall of the removable shell.

According to one embodiment, the first immobilization elements and the second immobilization elements are either for one protruding, fixed or retractable posts and for the other openings wherein the locking posts engage to secure the locking device on the removable shell.

According to one preferred embodiment, the locking device comprises a tilting or height adjustment system for the coupling seat in relation to the base.

According to one embodiment, the locking device comprises mechanical interfaces which are able to work with the gripping elements of a handling machine.

Finally, the invention presents a pocket wagon which comprises a receptacle railway structure and a removal loading/unloading system for a road semi-trailer, and therefore the removable assembly, supported by the railway structure, complies with the invention and comprises a removable shell removably engaged in the railway structure receptacle.

According to one embodiment, the railway structure also comprises positioning stops for the removable shell.

According to one embodiment, the railway structure also comprises localized support zones, of adjustable height, onto which the removable assembly is rested when the removable shell is pushed into the receptacle.

According to one preferred embodiment of this pocket wagon which comprises at least two bogies, when the removable shell is engaged in the railway structure receptacle, the removable assembly's free space, located under the front end portion of the longitudinal beams, is occupied by these bogies.

According to one preferred embodiment, the pocket wagon is a double wagon which comprises:

three bogies, consisting of two end bogies and one intermediate bogie, which may or may not be of the same type;

two receptacle railway structures, with each of these railway structures supported by one of the end bogies and by the intermediate bogie, with both railway structures preferably connected by an articulated link next to the intermediate bogie; and

two removable assemblies, each supported by one of the railway structures and for which the removable shell is removably engaged in the receptacle of the corresponding railway structure.

In addition, the free space under the front end of the longitudinal beams of each of these removable assemblies is advantageously occupied by one of the end bogies.

According to another embodiment, the pocket wagon may also be a train-type wagon which comprises several receptacle railway structures which are assembled one after the other and cannot be separated, and several removable assemblies, each being removable engaged in the receptacle of one of the railway structures.

Advantageously, the removable shell may also enable tractors, carriers or vans to be loaded. In these cases, the load should be locked in relation to the removable shell by wedging the axles.

Advantageously, the wagon may also transport receptacles, swap bodies or other elements. It then comprises adapted retention interfaces, which are preferably retractable and linked either to the shell or directly to the railway structures.

The invention therefore provides a simple and practical loading method for semi-trailer road transport, as well as a removable loading/unloading assembly and a pocket wagon intended to implement this method, which constitute a more economical alternative to traditional motorized rotating platform wagons.

This method also enables semi-trailers to be loaded and unloaded in complete safety, as they are already anchored by their coupling pin when they are positioned on the removable shell, before being loaded onto the railway structure.

In addition, this anchoring is simple and practical for the operator to implement without them needing to intervene on the railway structure.

Finally, thanks to its original structure, the removable assembly enables a significant amount of space to be saved in the wagon due to the embedding of a bogie under the angled section of the beams. Shorter and more compact wagons may then be produced.

It is also possible to use double wagons which are able to transport two semi-trailers at the same time and which are advantageously equipped with three bogies instead of four. Load distribution is optimized and a significant load transfer to the end bogies prevents the intermediate bogie from being overloaded.

According to another embodiment which may be used on rail networks which accept significant axle loads, the wagons may form an indivisible train type assembly without coupling. This configuration, an example of which is shown in FIG. 38, enables the number of bogies to be optimized to one per semi-trailer transported.

All of these advantages mean that the method according to the innovation is particularly inventive in relation to the problems posed by the methods of the prior art.

### BRIEF DESCRIPTION OF THE FIGURES

Other features and advantages of the invention will appear upon reading the detailed description which follows, which is made with reference to the accompanying drawings, wherein:

FIG. 1 is an overall perspective view of an example of a double pocket wagon according to the invention loaded with two semi-trailers;

FIG. 2 is a general perspective view of the double pocket wagon in FIG. 1 in the unloaded state;

FIG. 3 is a perspective view of an example of a receptacle railway structure adapted to accommodate a removable assembly according to the invention;

FIG. 4 is a perspective view of an example of a removable assembly according to the invention presented away from the railway structure;

FIG. 5 is a perspective view of the locking device for the removable assembly in FIG. 4, presented on its own;

FIG. 6 is a perspective view of the removable shell of the removable assembly in FIG. 4, presented on its own;

FIGS. 7 and 8 are perspective bottom views respectively of a first and second embodiment of the removable shell in FIG. 6;

FIGS. 9 to 13 correspond to a sequence of diagram views which illustrate the positioning and removal of the locking device on a removable shell equipped with a first embodiment of the positioning device;

FIGS. 14 to 19 correspond to a sequence of diagrammatic views which illustrate the positioning and removal of the locking device on a removable shell equipped with a second embodiment of the positioning device, as well as the positioning of the assembly on the railway structure;

FIGS. 20 to 26 correspond to a sequence of diagrammatic views which illustrate the positioning and removal of the locking device on a removable shell equipped with a third embodiment of the positioning device, as well as the positioning of the assembly on the railway structure;

FIGS. 27 to 31 correspond to a sequence of perspective schematic views which illustrate a first example of a loading method according to the invention;

FIGS. 32 to 35 correspond to a sequence of perspective schematic views which illustrate a second example of a loading method according to the invention; and

FIGS. 36 and 37 are perspective side views which illustrate two embodiments of removable shell positioning stop, in stop contact respectively with the edges of the platform in FIG. 36 and the railway structure in FIG. 37;

FIG. 38 is a general profile view of an example of a train-type pocket wagon according to the invention loaded with six semi-trailers.

### DETAILED DESCRIPTION

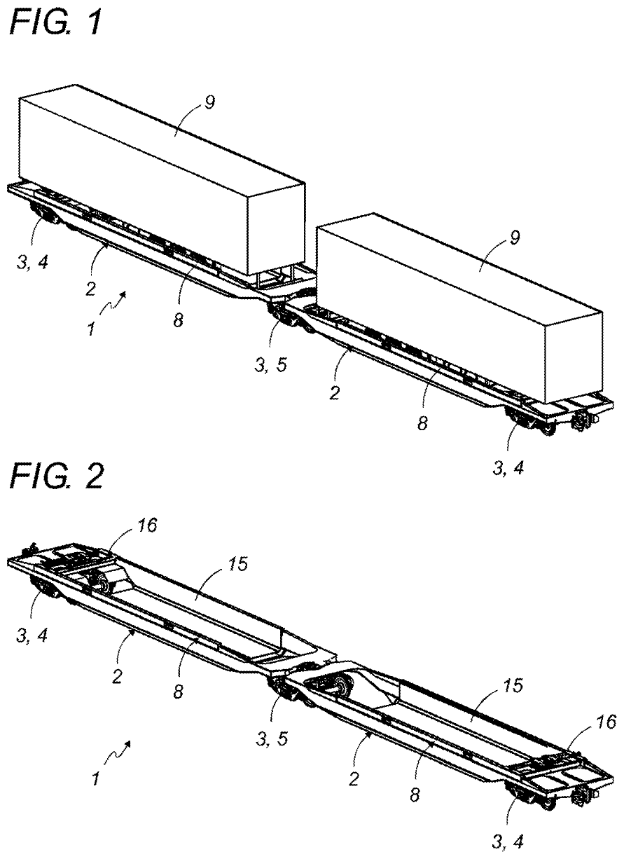

The loading method and the removable assembly according to the present invention will now be described in detail with reference to FIGS. 1 to 38. Equivalent items shown in different figures will bear the same reference numbers.

The notions of high and low, lower and upper, etc., will be further defined depending on the direction of the elements represented in the various figures.

In the same way, the front side of the removable assembly will be defined as the one containing the locking device, which also corresponds to the side with the front of the semi-trailer once it is loaded on the removable assembly according to the invention.

FIGS. 1 and 2 show an example of pocket wagon 1 according to the invention. In this example, this pocket wagon 1 comprises two railway structures 2 and three bogies 3, with two end bogies 4 and one intermediate bogie 5.

Each of the railway structures 2 is then supported by an end bogie 4 and a part of the intermediate bogie 5 They are articulated to each other next to intermediate bogie 5, with the link potentially made advantageously according to the UIC type (ball joint which absorbs all efforts) or according to any other type of link known to a person skilled in the art and recognized in the rail field.

Each of these railway structures 2 comprises a hollow central zone 6 which forms a receptacle 7 with the form and dimensions adapted to accommodating a removable assembly 8 according to the invention. These two railway structure 2 are largely identical, except for specific features of the link, but are arranged in reverse to each other.

This type of wagon is particularly advantageous as it enables two semi-trailers 9 to be transported at the same time as shown in FIG. 1, with each of these semi-trailers loaded on a removable assembly 8 and supported by a railway structure 2.

Of course, and even if this is not shown, it is also possible to produce a single pocket wagon 1, which is more traditional and which only has one railway structure supported by two end bogies. In this case, to transport two semi-trailers, two pocket wagons must be used, coupled to each other, and therefore four bogies. The double pocket wagon 1 shown in the figure enables a shorter and more compact rail assembly to be produced, limiting the number of bogies required.

Conversely, a train-type pocket wagon 1 may be produced, for example like the one shown in FIG. 38, where several railway structures 2 are assembled one after the other, indivisibly and without coupling, with each one supported by a single bogie 3, except for the last one which rests on two bogies 2.

Each of the railway structures 2 of the train comprises a receptacle 7 which may accommodate a removable assembly 8 and may therefore transport one semi-trailer 9. This configuration advantageously enables the number of bogies 3 to be limited to one per semi-trailer 9 transported.

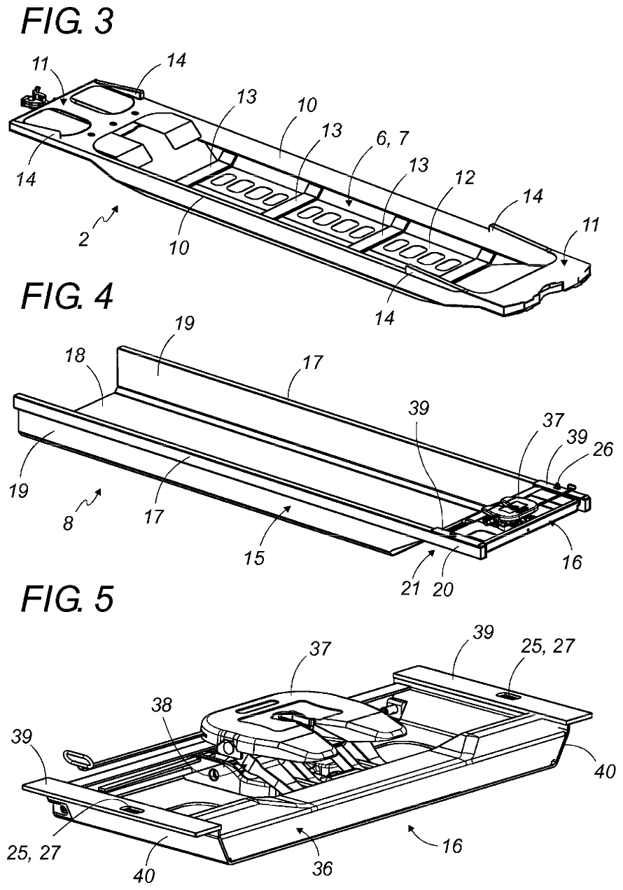

One railway structure 2 has been shown on its own and as an example in FIG. 3. This railway structure 2 may advantageously be very simple. It thus comprises two upper spars 10 which participate in the structural resistance of the wagon and which are used to support the weight of the removable assembly 8 intended to be placed on them. These upper spars 10 are linked by two end sections 11, intended to rest on the corresponding bogies 3. These end portions 11 comprise the articulation and coupling interfaces needed to constitute and operate the pocket wagon, and to couple it to the adjacent wagons.

Between these upper spars 10 and these end portions 11 is the hollow central zone 6 which extends downwards, between the bogies 3 and which constitutes the receptacle 7. This receptacle 7 is marked out in its lower section by a bottom wall 12, preferentially open to save weight, or more simply by a set of crossbeams such as 13 which link the two upper spars 10 and provide rigidity for the railway structure 2. This bottom wall 12 and/or these crossbeams 13 may also take, if necessary, part of the weight of the removable assembly 8 according to the invention when it is engaged in the receptacle 7.

This receptacle 7 may also be made without a bottom or with crossbeams 13 located outside the removable assembly 7 reception zone. In this case, the bottom wall 12 is removed and the crossbeams 13 are distributed to enable the removable assembly 8 to descend as low as possible, with it then resting only via its longitudinal beams on the upper spars 10.

Advantageously, the upper spars 10 may comprise localized support zones, which are preferably produced as adjustable height wedges; the removable assembly 8 then rests only on these localized supports zones and no longer on all of the upper spars 10.

The height of these localized support zones may be adjustable, on construction or preferably during use, depending on the loads transported in order to compensate for the crushing of the bogie suspension springs. It is then possible to align the bottom wall 18 of the shell 15 with the lower rail gage, or to adjust it so that the weight and distribution of the load and the ground clearance are kept constant, and therefore the loading height between the lower and upper gage, for all load states. In this case, the railway structure 2 should be produced open in its lower portion to avoid engaging the gage.

These localized support zones also enable avoidance of any debris, glass, piles of snow or other elements which may prevent the removable assembly 8 from positioning itself correctly on the railway structure 2.

The railway structure 2 also preferably has positioning stops 14, for example in clearly triangular form as show, located in the end zone of the upper spars 10 on each of the end portions 11. These positioning stops 14 are used to block the removable assembly 8 in position when it is engaged in the receptacle 7 as will be explained later.

To be multi-function, this railway structure 2 may also comprise locking interfaces for another type of load, such as a receptacle or a swap body, that may be transported in place of a semi-trailer. These interfaces, which are not shown in the figures, may be folding pins which are compatible with ISO wedges.

As shown in FIG. 4, the removable assembly 8 according to the invention comprises a removable shell 15 and a locking device 16.

The removable shell 15 which is shown on its own in FIGS. 7 and 8 comprises two longitudinal beams 17, a bottom wall 18 and two side walls 19 linking the bottom wall 18 to the longitudinal beams 17. The bottom wall 18 and the side walls 19 then constitute a loading pocket, suspended from the longitudinal beams 17, suitable to receive a semi-trailer 9.

Therefore, the bottom wall 18 is adapted to recovering the axles of the semi-trailer 9 and is compatible with the running of the semi-trailer's wheels which, as we will see later, runs on this bottom wall 18 when it is loaded and/or unloaded. In the same way, during these operations, the semi-trailer 9 and its handling tractor must be able to cross. The removable shell 15 therefore does not present any elements which will prevent this crossing.

Although not shown, the bottom wall 18 lay comprise in addition to reception elements for the wheels of the semi-trailer 9, hollow zones or wedging elements.

The side walls 19 may be produced either full or open, for example as a grid, a frame, strips or other elements.

According to the invention, two longitudinal beams 17, located in the upper section of the removable shell 15, comprise a front end portion 20 which extends at an angle towards the front beyond the bottom wall 18. A free space 21 is then defined under this front end portion 20 of the longitudinal beams 17 and at the front of the bottom wall 18.

The removable shell 15 also comprises mechanical interfaces 22 which enable it to be held by the gripping elements of a handling machine, in order to be raised and moved by it. These mechanical interfaces 22 are preferably located on the longitudinal beams 17 which generally constitute the most rigid part of the removable shell 15. In the example shown, these mechanical interfaces 22 may be a set of four rectangular openings 23 which are adapted to work with the clamps of a handling machine with clamps, such as a crane or gantry or a reach stacker. These openings 23 may also be replaced or enhanced with ISO wedges located at the end of the longitudinal beams 17.

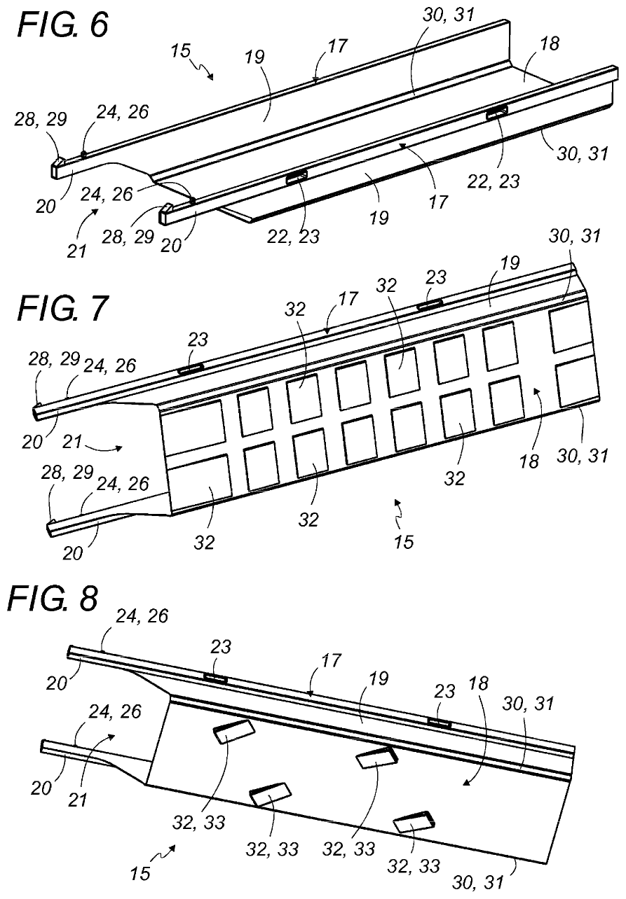

The front end portion 20 of the longitudinal beams 17 is intended to accommodate the locking mechanism 16 which attaches on top of it. To do so, it comprises the first immobilization elements 24 provided to work with the second immobilization elements 25 supported by the locking device 16 to ensure that the locking device 16 is held on the removable shell 15. In the embodiment shown in FIGS. 6 to 8 and 9 to 13, these first immobilization elements 24 are simple protruding locking posts 26, which are fixed and work with the corresponding openings 27 laid out in the locking device 16. Thanks to their adapted format, the engagement of the protruding locking posts 26 into the openings 27 ensures the longitudinal and lateral locking of the locking device 16 in relation to the removable shell 15, and its vertical hold upwards according to standard practice in the receptacle wagon field. Clearly, these two types of immobilization element may be reversed, with the locking device 16 having protruding locking elements and the longitudinal beams 17 complementary openings.

Other immobilization systems, with different first and second immobilization elements 24 and 25 may of course be envisaged. For example, simply embedding the frame of the locking device 16 between the longitudinal beams 17 of the removable shell 15 may be enough to immobilize it for rail transport. In this case, the first immobilization elements 24 are the interior sides of the longitudinal beams 17 and the second immobilization elements 15 are the exterior sides of the locking device 16.

To facilitate the positioning of the locking device on the removable shell 15 as explained later, the removal shell 15 also preferably has a positioning device 28 located on the front end portion 20 of the longitudinal beams 17. According to one embodiment shown in FIGS. 6 to 8 and 9 to 13, this is a simple fixed front positioning stop 29, against which the locking device 16 stops when the openings 27 are opposite the protruding locking posts 26.

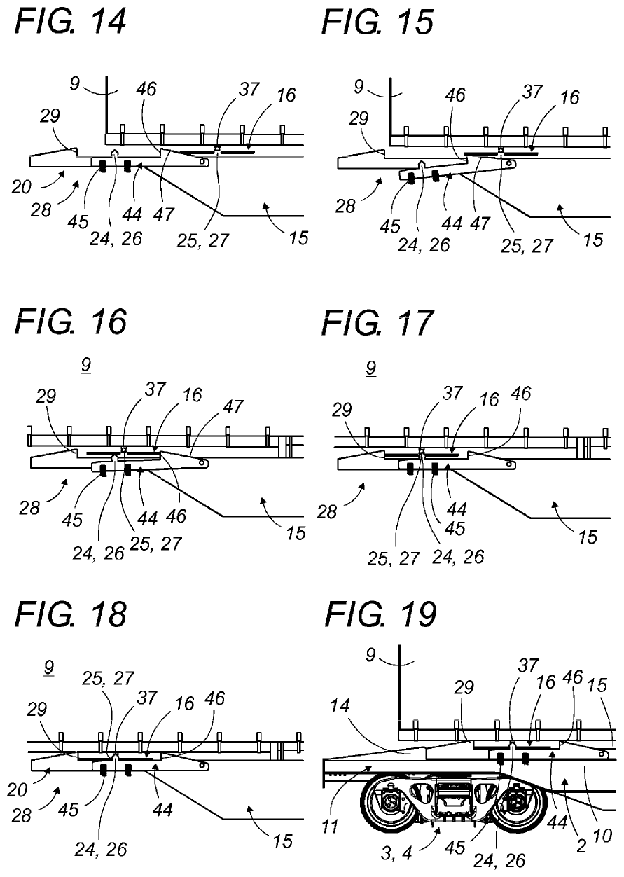

In FIGS. 14 to 26, other procedures for the immobilization elements 24 and this positioning device 28 were shown.

To facilitate its engagement and positioning in the receptacle 7 of the railway structure 2, the removable shell 15 may also comprise a centering device 30, which for example may be made as a set of two longitudinal chamfers 31 which link the side walls 19 to the bottom wall 18 of the removable shell.

Finally, the removable shell 15 may comprise on the underside of its bottom wall 18 several support elements 32 which are presented as crushing plates or runners, with a limited surface area. When the semi-trailer runs on the bottom wall 18, these support elements 32 enable the bottom wall 18 to remain on the ground even when it is not perfectly flat. This then prevents too much deformation of the removable shell 15 for which the side walls 19 may otherwise tend to close in on each other.

A first embodiment of these support elements 32 as a set of rectangular plates is illustrated in FIG. 7.

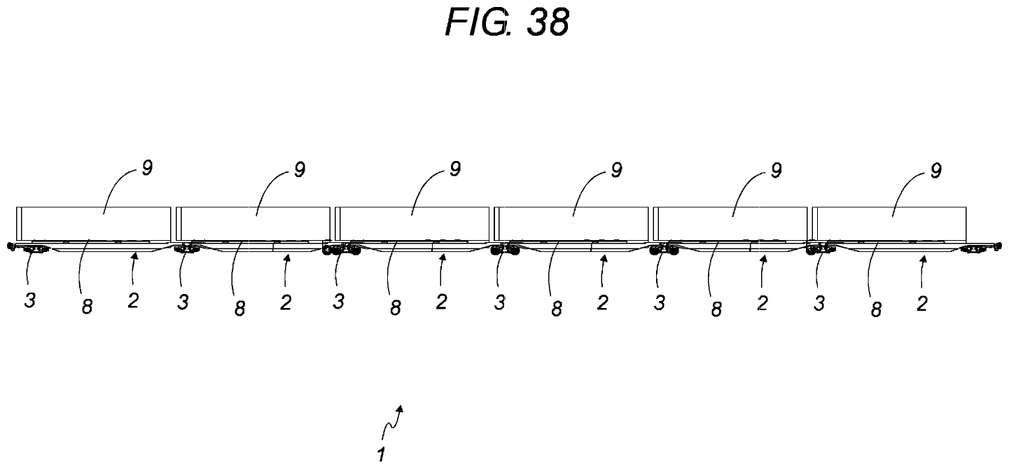

A second embodiment is shown in FIG. 8. This time, the support elements 32 are formed from four wedges preferably in the shape of corners 33 which are arranged in two diagonal rows. They are then placed and orientated to be able to act as a stop against the edges of the platforms 34 as shown in FIG. 34 or against the upper spars 9 of the railway structure 2 as shown in FIG. 37 to prevent the removable shell 15 sliding if the removable shell 15 is placed at an angle above the railway structure and across the railway line 35. In this case, the spacing between the two diagonal rows of support elements 32 corresponds to the one which exists between the two platform edges 34 or between the two upper spars 9 of the railway structure 2.

This embodiment is specially designed for use in dedicated terminals where the railway line is lower than the platforms (in a pit), with the railway structure 2 flush with the platform level 34. Nevertheless, it may be used as standard in non-dedicated terminals which are not equipped with a railway line sunk between two platforms raised in relation to it. For loading/unloading, it is then placed on the ground on the platform, like the previous embodiment. In this case, the corner shaped wedges 33 may be provided pivoting, folding or retractable, to be able to place the removable shell 15 directly on flat ground without damaging it.

A preferential example of a locking device 16 is shown in FIG. 5.

The locking device 16 comprises a base 36, for example as a frame and preferably flat and thin to avoid congesting the free space 21, on which a coupling seat 37 is assembled to accommodate and immobilize the coupling pin of the semi-trailer 9. According to one preferred embodiment, the locking device 16 also comprises a tilting or height adjustment system 38 for the coupling seat 37 in relation to the base 36.

Base 36 is a crossbeam which is removably attached to the front of the removable shell 15 and for which the ends 39 rest on the front end portion 20 of the longitudinal beams 17.

In this application, a “crossbeam” is a part of limited height, and preferably flat, which extends transversely in relation to the direction of the longitudinal beams 17 and which is attached to them by its ends.

This crossbeam also presents, for example, on the underside, mechanical interfaces which are adapted to the gripping elements of a handling machine and which enable it to be locked on a handling tractor to load the semi-trailers present on the platform as will be described later.

According to one preferred embodiment, the base 36 of the locking device 16 comprises, on each of its ends 39, and edge profile 40 with reversed L section, which constitutes a flat edged support wedge bracket intended to rest on the front end portion 20 of the longitudinal beam 17 corresponding to the removable shell 15.

The second immobilization elements 25 of the locking device 16 are located at these ends 39. These are preferably openings 27 made in the edge profile 40.

The exterior side of the base 36, which corresponds to the vertical part of the L, may be conformed in chamfer in its lower section to facilitate its engagement between the longitudinal beams 17 of the shell 15. The upper portion of this exterior side is then against the beams 17, centering or even immobilizing laterally the locking device 16. These arrangements, which may be completed by a set of longitudinal stops, may sometimes be enough to immobilize the locking device 16 for trail transport, and vertical retention is not always necessary.

As the locking device 16 is attached to the removable shell 15, not to the bottom wall 18, but the front end portions 20 of the longitudinal beams 17 like a crossbeam, the free space 21 remains completely free once the locking device 16 is in place. It may therefore be occupied by a bogie 3 of the pocket wagon 1.

As can be seen in FIG. 2, when the removable assembly 8 according to the invention is engaged into the receptacle 7 of the railway structure 2, the longitudinal beams 17 of the removable shell 15 are supported by the upper spars 10 of the railway structure 2 whereon they rest, and the front end section 20 of the longitudinal beams 17 and the locking device 16 extend over the corresponding end portion 11 of the railway structure 2.

The distribution of the weight of the semi-trailer 9 that must be supported by the pocket wagon 1 is optimized. In fact, a significant part of this weight, corresponding to the weight of the front section of the semi-trailer and applied via its coupling pin, is supported by the end section 11 of the railway structure 2 and therefore directly by the end bogie 4, with the receptacle 7 only needing to support the part of the weight which corresponds to the rear of the semi-trailer which is applied via its wheels.

In addition, thanks to this highly advantageous angle, the length of the receptacle 7 of the railway structure 2 may be reduced in relation to the length of the earlier pocket wagons in which the locking device also had to be housed. The railway structure is therefore much shorter and more compact that those in the prior art, which enables better engagement of the load in the rail gage. In addition, for the same total length of the train followed by the successive assembly of these pocket wagons, the number of wagons in significantly increased, which provides substantial savings for the operator.

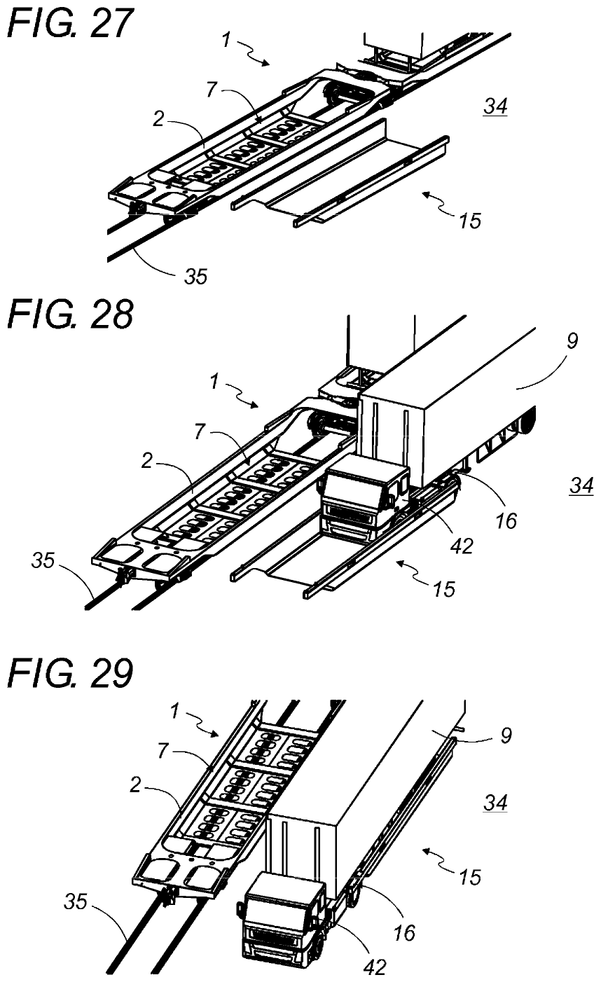

The loading method according to the invention of a semi-trailer on the removable assembly 8 then the railway structure 2 of the pocket wagon 1 will now be described. Two embodiments of this method have been outlined in diagrams in FIGS. 27 to 35.

The first of these embodiments, which is shown in FIGS. 27 to 31, may be produced in any loading terminal, whether or not it is dedicated to multimodal transport. It does not require any specific layout of the railway line 35 or the platforms 34.

To load, the removable shell 15 is placed flat on the platform 34 near the railway structure 2 as shown in FIG. 27. The removable shell 15 may come from a storage area in the terminal or have been brought in by the pocket wagon 1, which was traveling empty or which was previously unloaded from a previous load. It is placed on the platform with a standard handling machine 41 depending on the equipment in the terminal. This may be either a handling machine such as a crane or gantry, or as shown a running vehicle, such as a reach stacker.

The semi-trailer 9, which was previously left by its road tractor, on its stands, is equipped with the locking device 16 by a handling tractor 42 which places it by engaging the coupling seat 37 with its coupling pin. If necessary, the height of the coupling seat 37 in relation to the base 36 of the locking device 16 is adjusted to provide a horizontal transport position for the semi-trailer 9. This adjustment also enables the height of the coupling seat 37 to be adapted according to the semi-trailer 9 model to have a constant total height for the assembly. The locking device 16 may be placed on the semi-trailer either before, after or at the same time as the removable shell 15 is placed on the platform, depending on the operator's wishes.

The handling tractor 42 then brings the semi-trailer 9 equipped with the locking device 16 to the removable shell 15, as shown in FIG. 28. To do so, it passes between the longitudinal beams 17 and runs on the bottom wall 18 of the removable shell 15, in forward or reverse, until it places the semi-trailer 9 in loading position on the removable shell 15.

When the locking device 16 is above the front end zone 20 of the longitudinal beams 17, the handling tractor 42 lowers the locking device 16 to connect the first immobilization elements 24 with the second immobilization elements 25 and so block the locking device 16 on the removable shell 15 as shown in FIG. 29. This operation may be facilitated by the presence of chamfers on the exterior sides of the crossbeam.

The semi-trailer 9 is then anchored by its coupling pin to the removable assembly 8 according to the invention resting lightly on the stands following a bend in the end position 20 of the beams 17 of the shell 15. The semi-trailer 9 is then immobilized in a fixed position, longitudinal, laterally and vertically if necessary, in relation to the shell 15, regardless of its height and wheel base. This means that there are no risks during the later lifting operations.

The handling tractor 42 is then released and moves away from the semi-trailer 9. To do so it may completely cross the removable shell 15.

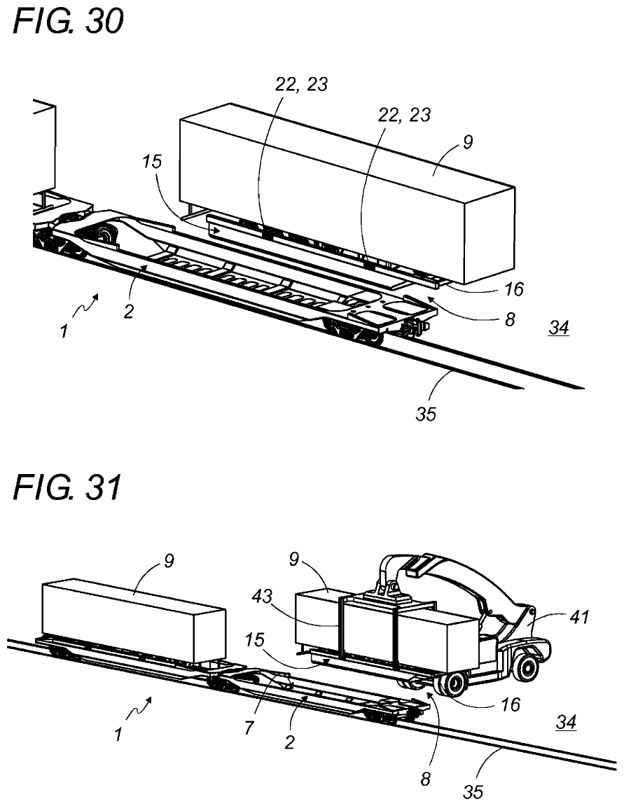

The removable assembly 8 according to the invention, loaded with the semi-trailer 9, is then ready to be placed on the railway structure as shown in FIG. 30.

The handling machine 41 then takes the loaded removable assembly 8, engaging its gripping elements 43, for example clamps, into the mechanical interfaces 22 in the removable shell 15 and raises it as shown in FIG. 31.

It then places it on the railway structure 2 by engaging the removable shell 15 into its receptacle 17. It is assisted by the centering device 30 which facilitates the insertion of the shell 15 into the receptacle 7. The handling machine 41 then releases the removable assembly 8 when the longitudinal beams 17 are on the upper spars 10 of the railway structure 2 and preferably on their localized support zones, which may be adjusted according to the load, to optimize bending and the constraints on the railway structure 2 or the shell 15.

These localized support zones may be situated as near as possible to the locking device 16 to limit the constraints in the longitudinal beams 17 and compensate for the bending on the front end portions 20 of these beams 17, which consequently also enables the front of the semi-trailer 9 to be raised slightly and so relieve the load taken by the stands during rail transport.

The correct positioning of the removable assembly 8 on the railway structure 2 is guaranteed by the presence of the positioning stops 14 in the end zone of the upper spars 10 and against which the ends of the longitudinal beams 17 are touching. The removable assembly 8 is then blocked laterally by the insertion of the removable shell 15 into the receptacle 7 and longitudinal by these positioning stops 14. The loading of the removable assembly 8 on the railway structure 2 is then complete and the pocket wagon 1 is ready for departure. The semi-trailer 9 is perfectly anchored without the operator needing to intervene on the wagon. It is immobilized in a centered and known position, longitudinally, vertically and laterally. The rail gage is then respected regardless of the load.

Once transport is complete, the semi-trailer 9 loading operations are carried out in the same way in the opposite direction.

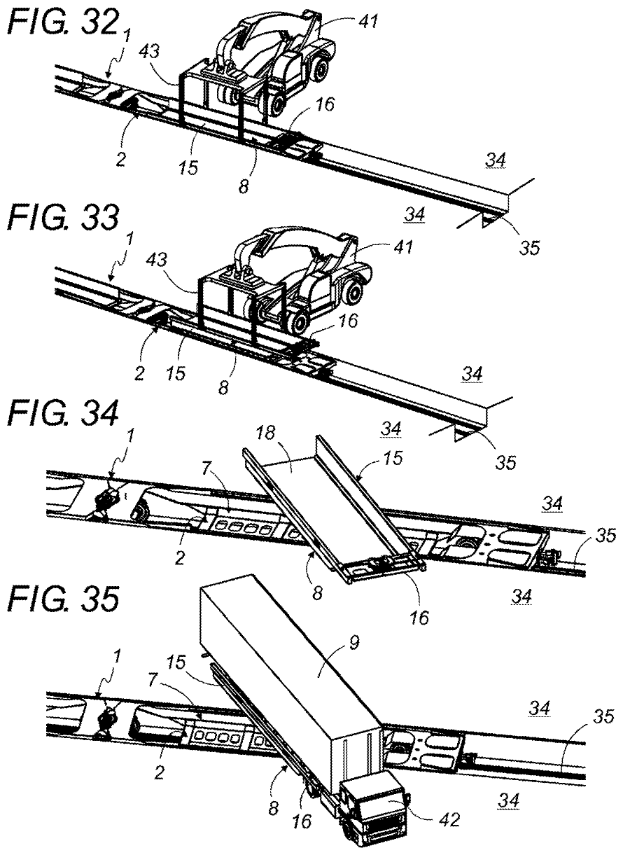

The second embodiment of the loading method is shown in FIGS. 32 to 35. This embodiment requires a laid out loading/unloading zone in which the railway line 35 is embedded, which means that its level is lowered in relation to the level of the platforms 34, so that the top of the railway structure 2 is flush with the level of the platforms 34 when the pocket wagon 1 is in this zone.

According to this embodiment, to load, the removal shell 15 is first taken by the handling machine which engages its gripping elements into the mechanical interfaces 22, as shown in FIG. 32.

The handling machine 41 then raises the removable shell 15 above the railway structure 2 and takes it out of the receptacle 7, as shown in FIG. 33.

It then pivots it by an appropriate angle to place it diagonally, for example around approximately 45° and puts it back on the railway structure 2, crosswise in relation to the railway line 35, as shown in FIG. 34.

In FIGS. 32 and 33 and in the paragraphs above, we assumed that the removable assembly 8 was initially in the receptacle 7 of the railway structure 2. If it is not, for example if it came from a terminal storage zone, the handling machine 41 would place it directly at a diagonal above the railway structure 2, crosswise in relation to the railway line 35, as shown in FIG. 34.

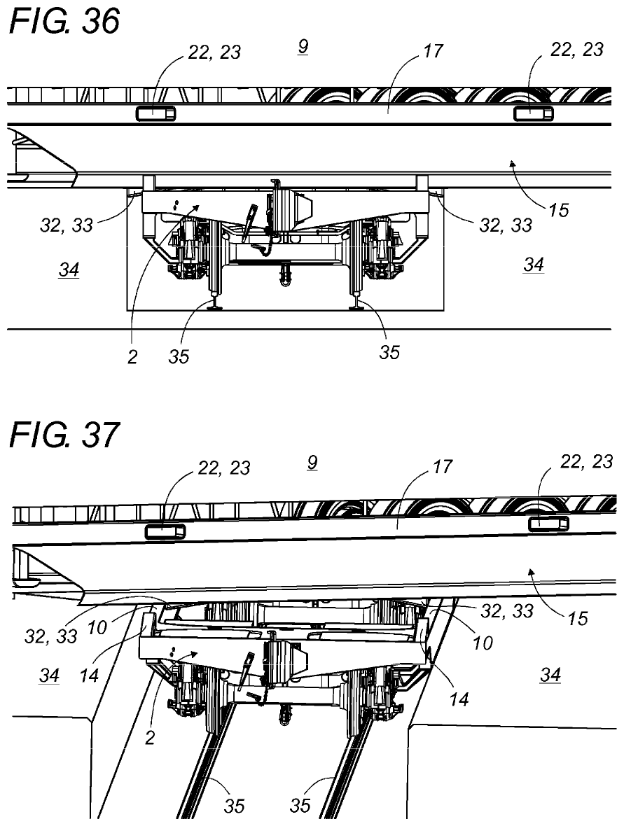

When it is in this position, the removable shell 15 is maintained longitudinally in position by the support elements 32 present on the underside of its bottom wall 18. In fact, these support elements 32, placed in two diagonal rows with adapted spacing, are at a stop in the opposite direction, according to the embodiments, against the two edges of the platform 34 as shown in FIG. 36, or against the two upper spars 10 of the railway structure 2 as shown in FIG. 37. This prevents longitudinal slippage of the removable shell 15, particularly when the handling tractor 42 and the semi-trailer 9 are running on the bottom wall 18.

Simultaneously, before or after, the semi-trailer 9 is equipped with the locking device 16 by the handling tractor 42.

If, as shown, the locking device was initially mounted on the removable shell 15, it must first be removed from it to be placed on the semi-trailer.

Then, and as in the previous embodiment, the handling tractor 42 which pulls the semi-trailer 9 mounts on the removable shell 15 and runs on the bottom wall 18 until it places the semi-trailer 9 in the loading position, as shown in FIG. 35.

The handling tractor 42 positions the locking device 16 on the end portion 20 of the longitudinal beams 17 then releases and moves away, available to load a new semi-trailer if necessary.

Advantageously, the handling tractor may mount on the removable shell 15 on one side of the railway line 35 and, after crossing the removable shell 15, descend on the other side, which is particularly useful during operation.

The handling machine 41 then takes the loaded removable assembly 8 and raises it again. It pivots it again to put it back in the same direction as the railway structure 2, then places it on the railway structure 2 by engaging the removable shell 15 into the receptacle 7.

The end of the loading method is identical to the previous embodiment. The unloading operations are carried out in the same way in the opposite direction.

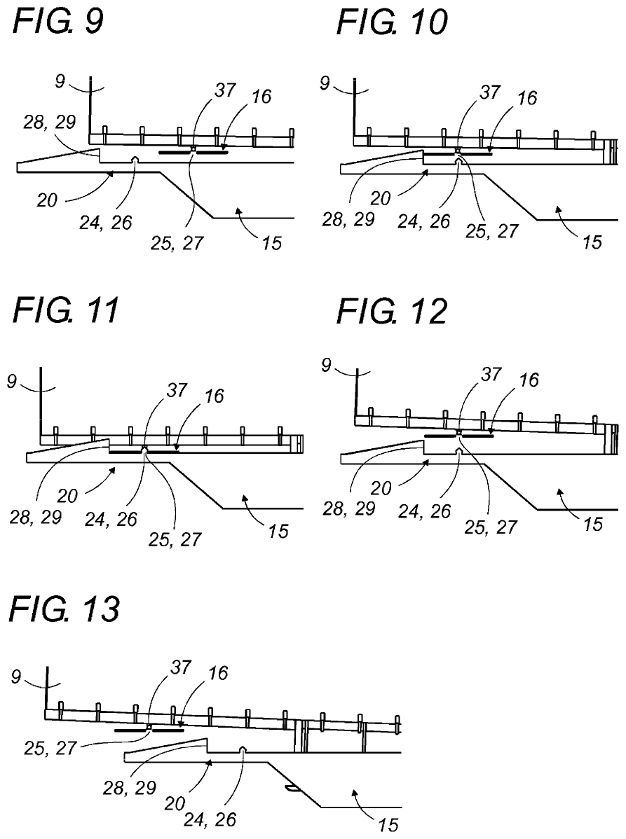

During these loading operations, the presence of a positioning device 28 on the longitudinal beams 17 makes it much easier for the operator to place the locking device 16 on the removable shell 15. The different steps in this positioning have been outlined in diagrams in FIGS. 9 to 26 for three embodiments of the positioning device 28.

In the basic embodiment, which is shown in FIGS. 6 to 13, the first immobilization elements 24 are fixed protruding locking posts 26 which rise out of the end portion 20 and the positioning device is composed of fixed positioning stops 29 at the front of the front end portion 20 and which are higher than the protruding locking posts 26. With this basic embodiment, the positioning method is as follows:

During loading, the handling tractor 42 inflates its suspension so that the ends 39 of the locking device 16, which is locked by its coupling seat 37 on the coupling pin of the semi-trailer 9, are at a height between that of the positioning stops 29 and that of the protruding locking posts 26 as shown in FIG. 9.

To load the semi-trailer 9 onto the removable shell 15, the handling tractor 42 runs on the bottom wall 18 and crosses it, passing between the longitudinal beams 17. It then brings the locking device 16 close to the front end portions 20 and advances gradually until the ends 39 of the locking device stop against the positioning stops 29 as shown in FIG. 10.

The operator then stops the handling tractor 42 as this stop indicates to them that the locking device 16 is correctly positioned, meaning that the openings 27 in the locking device 16 are exactly above the protruding locking posts 26 of the removable shell 15.

The operator then just needs to deflate the suspension of the handling tractor 42 or use a lifting resource, to lower the locking device 16 and enter the protruding locking posts 26 into the openings 27, until the locking device 16 is placed on the front end portions 20 of the longitudinal beams as shown in FIG. 11.

By engaging these posts 26 into the openings 27, the locking device is blocked laterally and longitudinally on the removable shell 15 and the semi-trailer 9 is anchored onto it. The handling machine 42 may move away as the removable assembly 8 is ready to be loaded onto the railway structure 2.

Next, to unload the semi-trailer 9, after coupling the handling tractor 42 again, the operator simply needs to inflate the suspension enough to raise the lifting device 16 above the end portions 20 to a height which exceeds the positioning stops 29, as shown in FIG. 12.

They then just need to move the handling tractor 42 forward to pass the locking device 16 above the positioning stops 29, as shown in FIG. 13, and to take the semi-trailer 9 away from the removable shell 15.

In the second embodiment shown in FIGS. 14 to 19, the first immobilization elements 24 are protruding locking posts 26 which are retractable. To do so, these posts are installed at the end of a lever 44 which is articulated by its other end on the corresponding longitudinal beam 17, to be able to pivot downwards to clear under the front end portion 20.

Each of these levers 44 is held in the raised position by an elastic recall device 45, for example, in the form of one or more springs as shown.

As previously, the positioning device 28 comprises fixed positioning stops 29 which are at the front of the front end portion 20, but which may be shorter than in the previous embodiment.

The positioning device 28 is completed by a jamming stop 46, located on the lever 44 at the rear of the protruding locking post 26 and which is thus retractable. Its rear side is produced as a progressive ramp 47 which facilitates the pivoting downwards of the lever 44 at the rear of the locking device 16 as explained below.

To position the locking device 16, the handling tractor 42 slightly inflates its suspension so that the ends 39 of the locking device 16 are just above the longitudinal beams 17, as shown in FIG. 14.

It then brings the locking device 16 close to the front end portions 20 by running on the bottom wall 18 of the removable shell 15. During this movement, the locking device 16 is first of all against the ramps 47, as shown in FIG. 14.

The continued movement of the handling tractor moves the locking device 16 forward against the ramps and pivots the levers 44 downwards, which enables the locking device 16 to pass above the jamming stops 46 located at the rear, as shown in FIG. 15.

As soon as the locking device 16 has fully crossed the jamming stops 46, the levers 44 start to rise under the effect of the elastic recall devices 45. However, their rise is limited by their protruding locking posts 26 pressing against the locking device 16, as shown in FIG. 16.

The operator stops the handling tractor 42 when the locking device 16 comes to a stop against the fixed positioning stops 29, as shown in FIG. 17. In this position, the openings 27 in the locking device 16 are exactly above the protruding locking posts 26 which cross them under the effect of the elastic recall devices 45 which push the levers 44 upwards, as shown in FIG. 17.

For example, the operator then simply needs to deflate the suspension of the handling tractor 42 to lower the locking device 16 to the front end portions 20, as shown in FIG. 18. The locking device 16 is then perfectly maintained, by the engagement of the protruding posts 26 into the openings 27, by the positioning stops 27 at the front and at the rear, by the jamming stops 46 which block it longitudinally and by the lateral centering of the edge profiles 40 against the beams 17 of the shell 15. The removable assembly 8 can then be loaded onto the railway structure 2 after the handling tractor 42 departs.

As we can see in FIG. 19, the locking of the locking device 16 on the removable shell 15 is reinforced further when the removable assembly 8 is in transport position on the railway structure 2. In fact, as the longitudinal beams 17 are then resting on the upper spars 10, the recall devices 45 are compressed and the levers 44 blocked in raised position, which guarantees maximum engagement of the protruding locking posts 26 into the openings 27.

Next, to unload the semi-trailer 9, after coupling the handling tractor 42 again, the operator simply needs to couple the handling tractor 42 again and inflate the suspension to raise the lifting device 16 above the end portions 20 to a height which exceeds the fixed positioning stops 29, then move forward to take the semi-trailer 9 away from the removable shell 15.

As these positioning stops 29 are lower than in the previous embodiment, the locking device 16 does not need to be raised so high. The semi-trailer 9 is then tilted less by the inflation of the suspension, which reduces any risk of damage by the bottom of its rear portion rubbing.

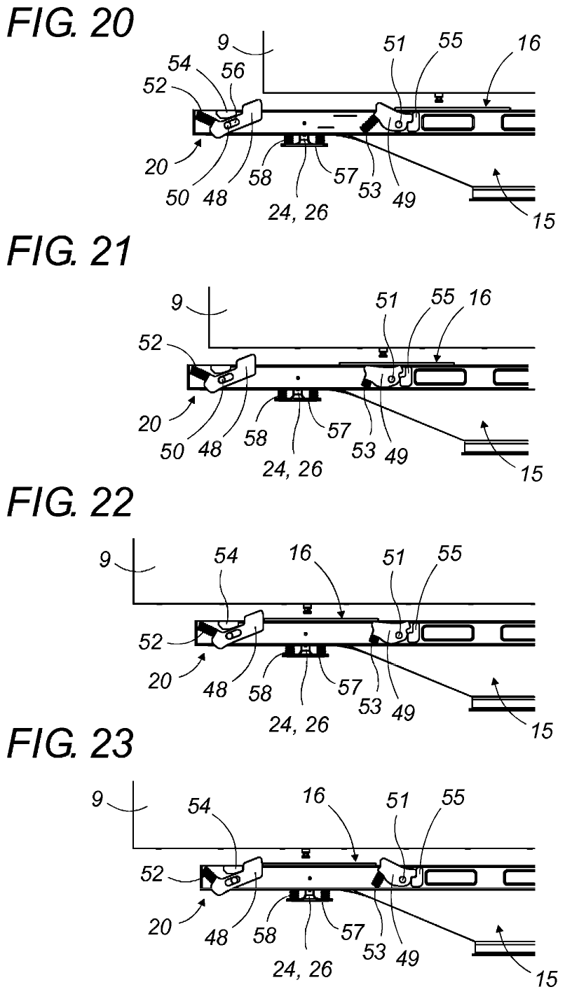

The third embodiment shown in FIGS. 20 to 26 enables the semi-trailer 9 to be loaded and unloaded without needing to raise it at the front. Any risk of damaging its rear portion is then avoided.

To do so, the positioning stops 29 and jamming stops 46 of the positioning device 28 are this time made as removable cams respectively 48 at the front and 49 at the rear.

These removable cams 48 and 49 are mounted pivoting around a transverse axis, respectively 50 and 51, fixed to the front end portion 20 of the beams. They are each constrained in a protruding raised position by an elastic recall device, respectively 52 and 53, for example such as a spring as shown and are limited in movement by a fixed stop, respectively 54 and 55, against which they come to a stop.

The front removable cam 48 comprises an oblong opening 64 through which its transverse pivoting axis 52 is engaged, which enables it to carry out a specific sequence of movements which will be detailed below.

The first immobilization elements 24 are protruding locking posts 26 which, as in the second embodiment, are retractable. These posts 26 are produced this time on a plate 57 which is pushed downwards by a set of springs 58 to that in rest position the locking posts 26 do not exceed the top of the front end portion 20 of the beams 17, as can be seen in FIG. 20.

To load, the operator adjusts the suspension so that the semi-trailer 9 is in horizontal transport position, without needing to raise the front of the semi-trailer to put the locking device 16 in place. The ends 39 of the locking device 16 are at the height of the upper side of the longitudinal beams 17, as shown in FIG. 20.

When the handling tractor 42 moves forward, the locking device 16 starts by coming against the rear removable cam 49, as shown in FIG. 20.

The forward movement of the locking device 16 causes this cam 49 to pivot around its axis 51 and its gradual downward movement compressing the elastic recall device 53, which enables the locking device 16 to pass above the cam 49, as shown in FIG. 21.

The locking device keeps moving forward until it comes to a stop against the removable cam 48, as shown in FIG. 22. The locking posts 26 are then in retracted position and do not hinder this movement in any way.

The operator may then continue moving the locking device 16 forward by pushing the cam 48 and compressing the corresponding elastic recall device, until the cam 48 comes to a stop against the fixed stop 54, as shown in FIG. 23. This forward movement of the cam 48 is made possible by the sliding of its pivoting axis 50 in the oblong opening 56.

In this position, the locking device 46 has completely exceeded the rear removable cam 49, which pivots under the effect of the elastic recall device 53 until it returns against the fixed stop 55. It is then in protruding position and constitutes for the locking device 16 a jamming stop 46.

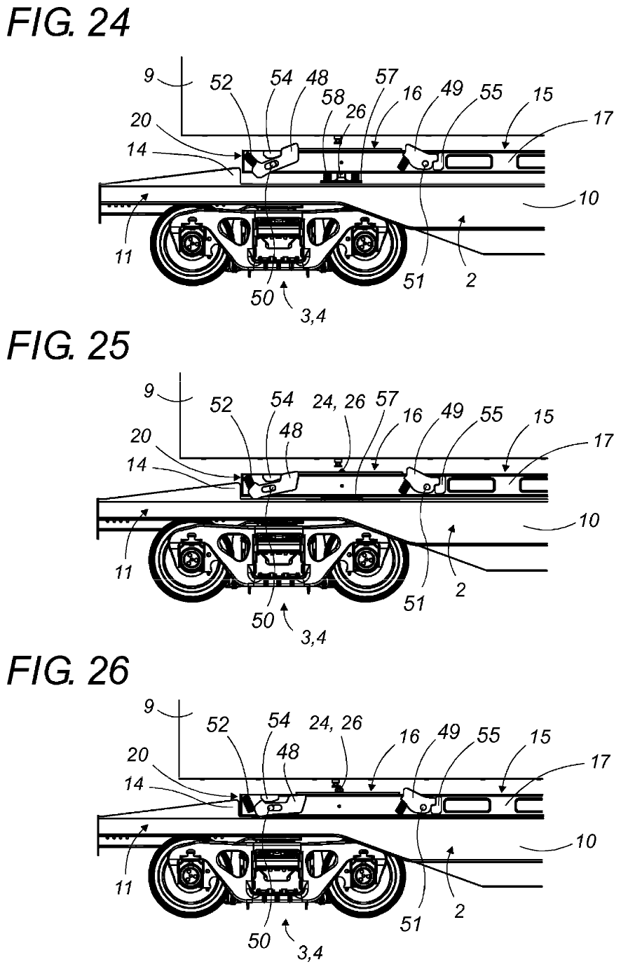

The locking device is then completely blocked longitudinally, at the front by the removable cam 48 which is protruding and at a stop and at the front against the fixed stop 54 and at the rear by the removable cam 49 which is protruding and at a stop at the rear against the fixed stop 55. It is also blocked laterally by the edge profile 40 which come up against the interior of the beams 17 of the shell 15. In this position, the openings 27 in the locking device 16 are positioned just above the protruding locking posts 26 and the removable assembly 8 may be loaded onto the railway structure 2, as shown in FIG. 24.

When the removable assembly 8 is placed on the railway structure 2, the longitudinal beams 17 are placed on the upper spars 10, which raises the plates 57 by compressing the springs 58. Therefore, the protruding locking posts 26 supported by these plates 57 cross the openings 27 in the locking device 16 opposite which they were positioned, completing the anchoring of the semi-trailer 9.

When the removable assembly 8 is moving downwards and as shown in FIG. 25, the lower end of the removable cams 48 comes up against the upper spars 10 of the railway structure 2, which gradually pivots these cams 48 horizontally.

When the removable assembly 8 is completely placed on the railway structure 2, the upper end of the cams 48 is slightly lower than the locking device 16. The cams 48 are then pushed towards the locking device 16 by the elastic recall devices 52 and engage partially below it by their pivoting axis 50 sliding in their oblong opening 56, as shown in FIG. 26. The front cams 48 are then completely removed and do not provide any additional thickness which hinders the unloading of the semi-trailer 9.

Once transport is complete, the removable assembly 8 is unloaded away from the railway structure by the handling machine 41 and lifting it automatically clears the protruding locking posts 26 from the openings 27 under the effect of the springs 58 which push the plate 57. The cams 48 remain in removed position under the locking device 16.

Once coupled to the semi-trailer 9 again, the handling tractor 42 only needs to move forward, without needing to raise the semi-trailer 9 to unload it from the removable shell 15.

Obviously, the invention is not limited to the preferred embodiments described above and shown in the various figures, a person skilled in the art being able to make numerous modifications and imagine other embodiments without going beyond the framework and scope of the invention as defined by the claims hereinafter.

Therefore, for example, the positioning stops 29 described above as found at the front of the front end portion 20 of the longitudinal beams 47 may be located at the rear of these front end portions 20 in a procedure specified for loading the semi-trailers 9 in reverse. In this case, when the positioning device 28 has them, the jamming stops 46 are at the front of the far end portion 20 of the longitudinal beams 47 to be able to jam the locking device 16 longitudinally between the positioning stops 29 and the jamming stops 46 when it has reached an optimum longitudinal position so that the second immobilization elements 25 may work with the first immobilization elements 24.

1. A method for loading a road semi-trailer on a pocket wagon comprising a railway structure with a receptacle and a removable assembly for loading/unloading a road semi-trailer, comprising:
a removable shell, designed to be removably engaged in the receptacle of the railway structure, which comprises a bottom wall, two side walls and two longitudinal beams located in the upper portion above the side walls, with the assembly forming a loading pocket for the semi-trailer, and which also comprises first immobilization elements and mechanical interfaces able to cooperate with the gripping elements of a handling machine; and
a locking device, which comprises the second immobilization elements which work with the first immobilization elements to ensure the removable attachment of the locking device on the removable shell; and a coupling seat for the semi-trailer coupling pin to anchor the semi-trailer to the removable shell;
wherein the method includes the following steps:
grasping the removable shell by engaging the gripping means of a handling machine in the removable shell's mechanical interfaces, and, using the handling machine, raising the removable shell and placing the removable shell away from the railway structure receptacle;
fitting the locking device on the semi-trailer which was previously left by the semi-trailer's road tractor, by engaging the semi-trailer coupling pin into the coupling seat of the locking device;
loading the semi-trailer equipped with the locking device onto the removable shell using a handling tractor, running the semi-trailer forward or in reverse onto the bottom wall of the removable shell, between the side walls and the longitudinal beams;
using the lifting tractor, placing the locking device on the removable shell, in a position allowing the second immobilization elements to cooperate with the first immobilization elements;
releasing the handling tractor and moving away the removable assembly;
grasping the loaded removable assembly by engaging the handling machine's gripping means in the mechanical interfaces of the removable shell and lifting the loaded removable assembly;
using the handling machine, placing the loaded removable assembly onto the railway structure, by engaging the removable shell in the receptacle of the railway structure.

2. A loading method according to claim 1, wherein before being grasped and lifted with the handling machine, the removable shell is engaged in the receptacle of the railway structure or is in a storage zone.

3. A loading method according to claim 1, the railway structure being on a railway line near a platform, wherein during the step consisting of moving the removable shell out of the receptacle of the railway structure, the handling machine places the removable shell beside the railway structure on the platform or on top of the railway structure crosswise in relation to the railway line.

4. A loading method according to claim 3, wherein when the removable shell is placed on top of the railway structure crosswise in relation to the railway line, the removable shell is maintained in longitudinal position using support elements present on the underside of the removable shell bottom wall which are against the edges of the platform or of the railway structure.

5. A loading method according to claim 1, wherein when the removable shell is lifted and placed out of the receptacle of the railway structure using the handling machine, a first semi-trailer is on the removable shell and wherein this first semi-trailer is unloaded out of the removable shell before a second semi-trailer is loaded on the removable shell, during the step which involves loading the semi-trailer equipped with the locking device on the removable shell using a handling tractor, running the semi-trailer forward or in reverse on the bottom wall of the removable shell, between the side walls and the longitudinal beams.

6. A loading method according to claim 1, wherein when the semi-trailer equipped with the locking device is loaded onto the removable shell using a handling machine, the handling tractor moves the locking device close to the longitudinal beams and moves gradually until the locking device touches the positioning stops of a positioning device which is on the removable shell, which indicates that the locking device is correctly positioned longitudinally so that the second immobilization elements can work with the first immobilization elements, before said first immobilization elements are engaged with said second immobilization elements.

7. A loading method according to claim 6, wherein after positioning the locking device longitudinally, the operator adjusts the handling tractor's height by deflating the handling tractor's suspension.

8. A loading method according to claim 6, wherein the locking device is blocked longitudinally on one side by said positioning stops and on the other by jamming stops of the positioning device.

9. Removable assembly for loading/unloading a road semi-trailer on a railway structure with a receptacle of a pocket wagon type wagon, enabling the loading method to be implemented according to claim 1,
this removable assembly comprising:
a removable shell, designed to be removably engaged in railway structure receptacle and comprising a bottom wall onto which the semi-trailer is loaded, and mechanical interfaces able to cooperate with the gripping elements of a handling machine to lift and lower the removable shell; and
a locking device, comprising a coupling seat for the semi-trailer coupling pin which is removably attached to the removable shell, on a side of the removable shell defined as being the front side, in order to anchor the semi-trailer to the removable shell;
the removable shell further comprises:
two longitudinal beams, located in the upper portion of the removable shell, and each comprising a front end portion which extends in a cantilevered fashion towards the front beyond the bottom wall,
first immobilization elements located on the front end portion of the longitudinal beams, and
two side walls, which border laterally the bottom wall and extend upwards to the longitudinal beams, with these side walls forming with the bottom wall a loading pocket for the semi-trailer; and
the locking device further comprising:
a base on which the coupling seat is assembled, with this base being a crossbeam which is removably attached by ends on the front end portion of the longitudinal beams, and
second immobilization elements which work with the first immobilization elements to hold the locking device on the removable shell;
removable assembly, such that when the locking device is secured to the removable shell, the space under the front end portion of the longitudinal beams remains free,
wherein the removable shell further comprises a positioning device, comprising two positioning stops, located one on each front end portion of the longitudinal beams, which, when the locking mechanism touches these positioning stops without said first immobilization elements being engaged with said second immobilization elements, guarantee an adapted longitudinal positioning for the locking device in relation to the removable shell so that the first immobilization elements and the second immobilization elements can cooperate.

10. A removable assembly according to claim 9, wherein the positioning device further comprises two jamming stops, located one on each front end portion of the longitudinal beams, which enable the locking device to be blocked longitudinally between the positioning stops and the jamming stops of the positioning device.

11. A removable assembly according to claim 10, wherein at least the positioning stops or the jamming stops are mobile, removable, retractable or tilting stops.

12. A removable assembly according to claim 9, wherein the removable shell further comprises a set of support element located on the underside of the bottom wall which are preferably pivoting, folding or retractable.

13. A removable assembly according to claim 12, wherein said support elements are laid out in two oblique rows.

14. A removable assembly according to claim 9, wherein the first immobilization elements and the second immobilization elements are indifferently as far as some are concerned protruding, fixed or retractable locking posts and as far as the others are concerned openings into which the protruding locking posts engage to secure the locking device on the removable shell.

15. A removable assembly according to claim 9, wherein the locking device comprises a tilting or height adjustment system for the coupling seat in relation to the base and mechanical interfaces able to cooperate with the gripping elements of a handling machine.

16. A pocket wagon comprising a receptacle railway structure having a receptacle and a removable assembly to load/unload a road semi-trailer, supported by the railway structure and comprising a removable shell removably engaged in the receptacle of the railway structure, wherein the removable assembly complies with claim 9.

17. A pocket wagon according to claim 16, wherein the railway structure further comprises localized support zones, of adjustable height, onto which the removable assembly comes to rest when the removable shell is engaged in the receptacle.

18. A pocket wagon according to claim 16, wherein the pocket wagon is a double wagon or a train-type wagon.
